(19) United States
(12) Patent Application Publication
(10) Pub. No.: US 2022/0189455 A1
(43) Pub. Date: Jun. 16, 2022

(54) METHOD AND SYSTEM FOR SYNTHESIZING CROSS-LINGUAL SPEECH

(71) Applicant: SPEECH MORPHING SYSTEMS, INC., San Jose, CA (US)

(72) Inventors: Darko PEKAR, Novi Sad (RS); Radovan Obradovic, Novi Sad (RS)

(73) Assignee: SPEECH MORPHING SYSTEMS, INC, San Jose, CA (US)

(21) Appl. No.: 17/550,770

(22) Filed: Dec. 14, 2021

Related U.S. Application Data
(60) Provisional application No. 63/125,206, filed on Dec. 14, 2020.

(51) Int. Cl. G10L 13/02; G10L 13/10; G06N 3/08

(52) U.S. Cl. CPC G10L 13/02; G06N 3/08; G10L 13/10

(57) ABSTRACT

A method for synthesizing cross-lingual speech includes receiving a request for synthesizing speech, the request for synthesizing speech including a target text document and a target language. Phonetic transcriptions are generated for the target text document. Prosodic annotations for the target text document are generated based on the target text document and the target language. Phone durations and acoustic features are generated based on the phonetic transcriptions and the prosodic annotations using a neural network. A speech corresponding to the target text document in the target language is synthesized based on the generated phone durations and acoustic features.

### CROSS-REFERENCE TO RELATED APPLICATION

The present application claims the benefit of priority to U.S. Provisional Application 63/125,206, filed on Dec. 14, 2020, in the United States Patent and Trademark Office, the entire contents of which are hereby incorporated by reference in their entirety.

### FIELD

Various embodiments of the present disclosure relate generally to speech processing. More particularly, various embodiments of the present disclosure relate to text-to-speech systems for synthesizing cross-lingual speech.

### BACKGROUND

Technological advancements in speech processing have led to proliferation of text-to-speech (TTS) systems that are configured to read text in a natural, human-sounding voice. Text-to-speech systems are now deployed in various applications such as, but not limited to, voice assistants in smartphones, conversion of e-books to audio books, or the like.

TTS systems are typically of three types- concatenative TTS systems, parametric TTS systems, and neural network-based TTS systems. The concatenative TTS systems rely upon high-quality speech samples of speakers that are combined together (i.e., concatenated) to form speech. Speech generated by the concatenative TTS is clear, but may not sound natural. Further, development of robust concatenative TTS systems requires prohibitively large databases of speech samples and long lead times. The parametric TTS systems generate speech by extracting, from speech samples of speakers, linguistic features (e.g., phonemes, duration of phones, or the like) and acoustic features of speech signals (e.g., magnitude spectrum, fundamental frequency, or the like). These linguistic features and acoustic features are provided, as input, to a vocoder that generates waveforms corresponding to desired speech signals. While the parametric TTS systems are modular and offer better performance in comparison to the concatenative TTS systems, the parametric TTS systems generate speech signals that are prone to contain audio artifacts (e.g., muffled audio, buzzing noise, or the like).

Improvements in software and hardware in recent times have enabled growth of neural-network (i.e., deep learning) based TTS systems, which offer significant performance improvements over the concatenative TTS systems and the parametric TTS systems. However, neural network-based TTS systems typically generate speech signals in a voice of a single speaker and require speech samples of polyglot speakers speaking various languages in training corpora. In other words, neural network-based TTS systems offer subpar performance when speech is to be generated in a speaker-language combination not included in the training corpora.

In light of the aforementioned problems, it is necessary to develop a technical solution that enables a neural network-based TTS system to generate speech in a speaker-language combination not included in a corresponding training corpora.

### SUMMARY

According to an aspect of one or more embodiments, there is provided a method for synthesizing cross-lingual speech, executed by a processor, the method comprising receiving a request for synthesizing speech, wherein the request for synthesizing speech comprises a target text document and a target language; generating phonetic transcriptions for the target text document; generating prosodic annotations for the target text document based on the target text document and the target language; generating phone durations and acoustic features based on the phonetic transcriptions and the prosodic annotations using a neural network; and synthesizing a speech corresponding to the target text document in the target language based on the generated phone durations and acoustic features.

According to additional aspects of one or more embodiments, apparatuses and non-transitory computer readable medium that are consistent with the method are also provided.

### BRIEF DESCRIPTION OF THE DRAWINGS

Various embodiments of the present disclosure are described below with reference to the accompanying drawings, in which:

FIG. 1 is a block diagram that illustrates an exemplary environment for synthesizing cross-lingual speech, in accordance with an exemplary embodiment of the present disclosure;

FIG. 2 is a block diagram that illustrates training datasets of FIG. 1, in accordance with an exemplary embodiment of the present disclosure;

FIG. 3 is a block diagram that represents a training server of FIG. 1, in accordance with an exemplary embodiment of the present disclosure;

FIG. 4 is a block diagram that illustrates training of a neural network of FIG. 3, in accordance with an exemplary embodiment of the present disclosure;

FIG. 5 is a block diagram that represents a synthesis server of FIG. 1, in accordance with an exemplary embodiment of the present disclosure;

FIG. 6 represents a flowchart that illustrates a method for training the neural network, in accordance with an exemplary embodiment of the present disclosure; and

FIGS. 7A and 7B, collectively represent a flowchart that illustrates a method for synthesizing cross-lingual speech, in accordance with an exemplary embodiment of the present disclosure.

### DETAILED DESCRIPTION

Further areas of applicability of the present disclosure will become apparent from the detailed description provided hereinafter. It should be understood that the detailed description of exemplary embodiments is intended for illustration purposes only and is, therefore, not intended to necessarily limit the scope of the present disclosure.

The accompanying drawings illustrate the various embodiments of systems, methods, apparatuses and non-transitory computer readable mediums, and other aspects of the disclosure. Throughout the drawings like reference numbers refer to like elements and structures. It will be apparent to a person skilled in the art that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa.

The features discussed below may be used separately or combined in any order. Further, various embodiments may be implemented by processing circuitry (e.g., one or more processors or one or more integrated circuits) or processing entities (e.g., one or more application providers, one or more application servers, or one or more application functions). In one example, the one or more processors may execute a program that is stored in a non-transitory computer-readable medium.

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. In one example, the teachings presented and the needs of a particular application may yield multiple alternate and suitable approaches to implement the functionality of any detail described herein. Therefore, any approach may extend beyond the particular implementation choices in the following embodiments that are described and shown.

References to “an embodiment”, “another embodiment”, “yet another embodiment”, “one example”, “another example”, “yet another example”, “for example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

Various embodiments of the present disclosure are directed to improved cross-lingual speech synthesis. Cross-lingual speech synthesis may be used to produce the voice of a desired speaker in a desired language and speaking style regardless of the language of the input text. In multi-lingual or cross-lingual speech synthesis, discrepancies between linguistic features across languages create problems because two languages usually do not share the same phonological inventory. Although it may be possible to identify certain phonemes as common to multiple languages in a cross-lingual scenario, treating them as common to multiple languages decreases the overall accuracy and efficiency of the neural network because there may still be slight differences at the phonetic level. Embodiments of the present disclosure treat all phonemes from all languages as separate entities by uniquely representing the phonemes as one-hot vectors and them embedding them into low-dimensional space. The distance between the points representing the phonetic embedding space reflects the degree of similarity between corresponding phones and/or phonemes regardless of their language. Additionally, the phonetic transcription and/or embeddings according to embodiments of the present disclosure achieve dimensional reduction. Dimensional reduction allows the neural network to decide how similar the phonemes are across languages without expert knowledge to match phonemes across languages.

Various embodiments of the present disclosure disclose a system and a method for synthesizing cross-lingual speech. A training server, receives from a database, training datasets that include a set of speech samples of a set of speakers in a set of languages. The training server trains, based on phonemes included in each speech sample, a speaker identifier (ID) of each speaker, and language-specific, speaker-agnostic prosodic features of each speech sample, a neural network to learn speaking characteristics of each speaker, of the set of speakers, and phonemes and prosodic features of each language, of the set of languages. Following the training of the neural network, the training server may communicate the trained neural network to a synthesis server. The synthesis server may receive a request for synthesizing speech. The received request may include a target text document in a target language, of the set of languages, and a target speaker of the set of speakers. The request indicates that the target text document is to be read out in the target language in a voice of the target speaker. Based on the received request, the synthesis server may provide, to the trained neural network as input, phonemes included in the target text document, language-specific, speaker-agnostic prosodic features of the target text document, and a speaker ID of the target speaker. Based on the input, the trained neural network generates, as output, a set of phone durations and a set of acoustic features. The set of phone durations and the set of acoustic features are provided, by the synthesis server, as input to a vocoder for synthesizing a waveform for a speech signal. The vocoder generates the waveform that corresponds to the target text document being read out in the target language in the voice of the target speaker. Speech is synthesized based on the waveform generated by the vocoder.

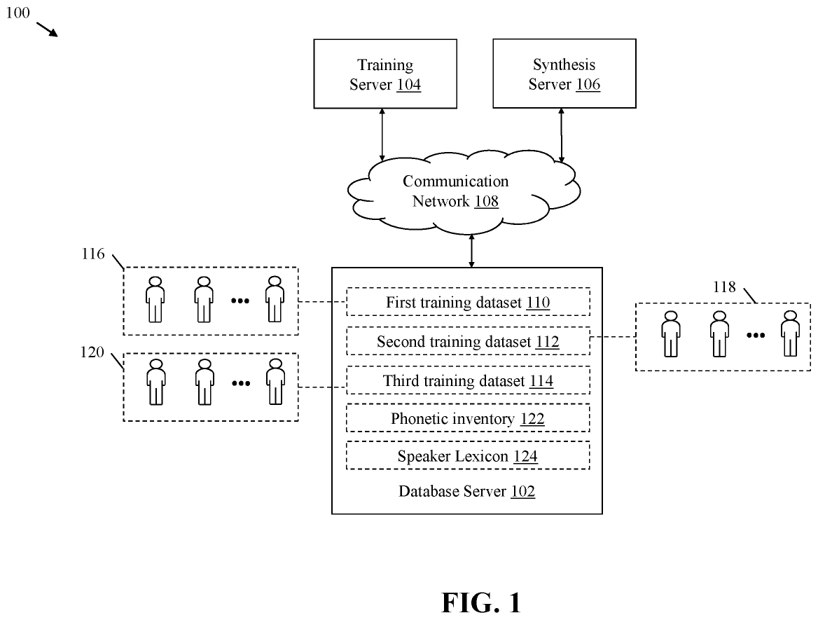

FIG. 1 is a block diagram that illustrates an exemplary environment 100 for synthesizing cross-lingual speech, in accordance with an exemplary embodiment of the present disclosure. The environment 100 includes a database server 102 and a training server 104, and a synthesis server 106. The database server 102, the training server 104, and the synthesis server 106 communicate with each other by way of a communication network 108.

The database server 102 is a server arrangement which includes suitable logic, circuitry, interface, and code, executable by the circuitry, for storing, therein, training datasets for training a neural network to synthesize cross-lingual speech. In a non-limiting example, the database server 102 is shown to include three training datasets (i.e., first through third training datasets 110-114). Each of the first through third training datasets 110-114 may correspond to a different language. For example, the first through third training datasets 110-114 may correspond to American English, Mexican Spanish, and Castilian Spanish, respectively. For the sake of brevity, American English, Mexican Spanish, and Castilian Spanish are interchangeably referred to as first through third languages, respectively. The first through third training datasets 110-114 are associated with first through third sets of speakers 116-120, respectively. In the current embodiment, the database server 102 is shown to include training datasets for only three languages (i.e., American English, Mexican Spanish, and Castilian Spanish). However, it will be apparent to those of skill in the art that the database server 102 may include training datasets for any number of languages without deviating from the scope of the disclosure. Each training dataset, of the first through third training datasets 110-114, may include speech samples, of a corresponding set of speakers of the first through third sets of speakers 116-120. Each training dataset of the first through third training datasets 110-114 includes phonetic transcriptions of corresponding speech samples, and prosodic annotations of the corresponding speech samples. The database server 102 further includes, therein, a phonetic inventory 122 and a speaker lexicon 124.

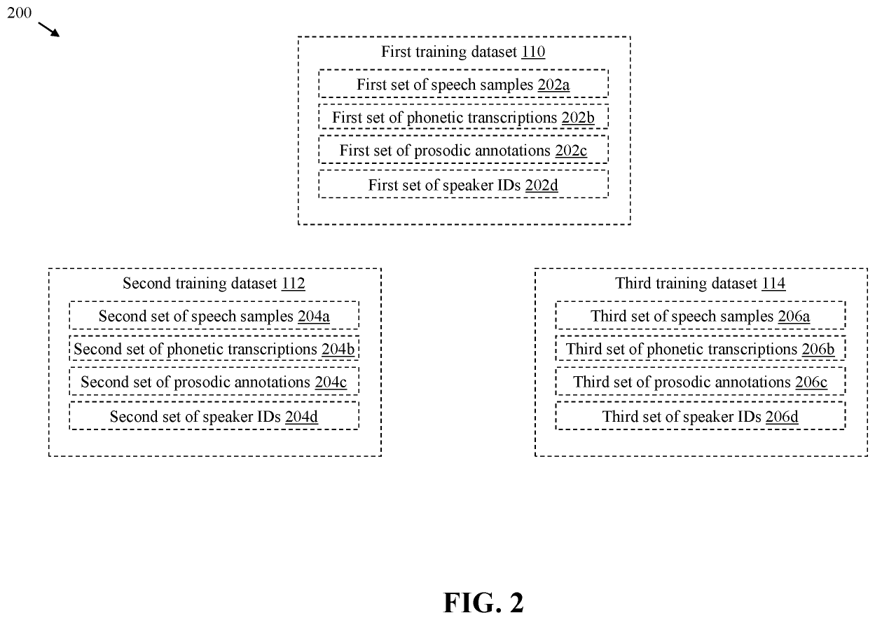

The phonetic inventory 122 stores phonemes used in the first through third languages. In one embodiment, phonemes corresponding to different languages (i.e., the first through third languages), but considered same by International Phonetic Alphabet (IPA), may be treated as separate in order to account for subtle differences between these phonemes. In a non-limiting example, if the first through third languages include 44, 25, and 25 phonemes, respectively, the phonetic inventory 122 stores a total of 94 phonemes. The speaker lexicon 124 stores speaker IDs of the first through third sets of speakers 116-120. In some embodiments, the speaker lexicon 124 may further store speaking characteristics of each speaker of the first through third sets of speakers 116-120. The first through third training datasets 110-114 are explained in conjunction with FIG. 2. The database server 102 may be implemented as a cloud-based server. Examples of the database server 102 may include, but are not limited to, Hadoop, MongoDB®, MySQL®, NoSQL , and Oracle®.

Referring now to FIG. 2, a block diagram 200 that illustrates the first through third training datasets 110-114, in accordance with an exemplary embodiment of the present disclosure, is shown. FIG. 2 is explained in conjunction with FIG. 1. The first training dataset 110 is shown to include a first set of speech samples 202a, a first set of phonetic transcriptions 202b, a first set of prosodic annotations 202c, and a first set of speaker identifiers (IDs) 202d. Similarly, the second training dataset 112 is shown to include a second set of speech samples 204a, a second set of phonetic transcriptions 204b, a second set of prosodic annotations 204c, and a second set of speaker IDs 204d. Similarly, the third training dataset 114 is shown to include a third set of speech samples 206a, a third set of phonetic transcriptions 206b, a third set of prosodic annotations 206c, and a third set of speaker IDs 206d.

Each set of speech samples (e.g., the first through third sets of speech samples 202a-206a) may be composed of speech samples of various speakers (e.g., the first through third sets of speakers 116-120) speaking a corresponding language in a native accent. The first set of speakers 116, associated with the first training dataset 110, may include speakers that are native speakers of American English. Similarly, the second set of speakers 118 may include speakers that are native speakers of Mexican Spanish. Similarly, the third set of speakers 120 may include speakers that are native speakers of Castilian Spanish. Each speech sample, of the first through third sets of speech samples 202a-206a, is an audio clip of a corresponding speaker speaking in a corresponding language. For example, a first speech sample in the first set of speech samples 202a may be a voice sample of a first speaker, of the first set of speakers 116, speaking American English in a native accent. Similarly, a second speech sample in the second set of speech samples 204a may be a voice sample of a second speaker, of the second set of speakers 118, speaking Mexican Spanish in a native accent. Each speech sample, of the first through third sets of speech samples 202a-206a, may include at least a few sentences worth of spoken content by a corresponding speaker.

Each speech sample of the first through third sets of speech samples 202a-206a may belong to various sources. Examples of the various sources include, but are not limited to, recordings of speeches of speakers in a studio, recordings of phone conversations of speakers, audio clips of casual conversations of speakers, or the like. The examples of the various sources may further include, but are not limited to, audio clips of newsreaders during news segments, audio clips of a radio jockey, audio clips of participants in podcasts, or the like. In some embodiments, each of the first through third sets of speech samples 202a-206a may be curated to include speech samples of speakers representative of various age groups (e.g., children, teenagers, young adults, or the like), various genders, various accents, or the like. However, in some embodiments, a single language that is spoken by speakers in significantly different accents may be classified or treated as different languages based on the different accents. For example, American English, as spoken by a speaker from California, may be classified as a language different from American English as spoken by a speaker from Kentucky or Alabama. In some embodiments, a set of speech samples (e.g., the first through third sets of speech samples 202a-206a) may include multiple speech samples of a same speaker. These multiple speech samples may be considered as belonging to different speakers if the multiple speech samples are obtained from different channels or sources. In some embodiments, a set of speech samples (e.g., the first through third sets of speech samples 202a-206a) may include multiple speech samples of a single speaker, such that each of the multiple speech samples corresponds to a specific tone (e.g., anger, frustration, nostalgia, relief, satisfaction, sadness, or the like). In such scenarios, each of the multiple speech samples may be considered as belonging to different speakers.

The first through third sets of phonetic transcriptions 202b-206b includes phonetic transcriptions of the first through third sets of speech samples 202a-206a. The phonetic transcription for each speech sample represents a set of phonemes present in a corresponding speech sample. The phonetic transcription for each speech sample is further indicative of each phoneme in the corresponding speech sample. Each phonetic transcription, of the first through third sets of phonetic transcriptions 202b-206b, may correspond to a phoneme representation scheme such as IPA, Carnegie Mellon University (CMU) pronouncing dictionary, or the like. Each of the first through third sets of phonetic transcriptions 202b-206b may be determined, by the database server 102 or any other entity, using automatic (i.e., computer-based) techniques, semi-automatic techniques, or manual techniques known in the art.

The first through third sets of prosodic annotations 202c-206c include prosodic annotations of the first through third sets of speech samples 202a-206a, respectively. The prosodic annotation of each speech sample, of the first through third sets of speech samples 202a-206a, is based on a corresponding speech sample and a phonetic transcription of the corresponding speech sample. Each of the first through third sets of prosodic annotations 202c-206c may correspond to one or more annotation schemes. Examples of the one or more annotation schemes include, but are not limited to, tone and brake indices (ToBI), intonal variation in English (IViE), or the like. In some embodiments, a single annotation scheme may be used for annotating speech samples in different languages (e.g., the first through third languages). In other embodiments, different annotation schemes may be used for annotating speech samples in different languages. For example, regular TOBI may be used for annotation of speech samples in English. Similarly, Spanish ToBI (Sp_TOBI) may be used for annotation of speech samples in Spanish. Japanese ToBI (J_ToBI) may be used for annotation of speech samples in Japanese. Examples of prosody annotations in ToBI include, but are not limited to, tonal events (e.g., pitch accents, phrase accents, or boundary tones), break indices indicative of length of breaks or gaps in between syllables, or the like.

The prosodic annotation for each speech sample, of the first through third sets of speech samples 202a-206a, includes a set of abstract prosody tags that corresponds to language-specific, speaker-agnostic prosodic features of a corresponding language. The set of abstract prosody tags is used to indicate features that are common to speakers of a language such as stress on each phoneme or word in a speech sample, phase break between consecutive syllables, rising or falling intonation of syllables or words, or the like. Each of the first through third sets of prosodic annotations 202c-206c may be determined, by the database server 102 or any other entity, using automatic (i.e., computer-based) techniques, semi-automatic techniques, or manual techniques known in the art.

The first through third sets of speaker IDs 202d-206d include speaker IDs of speakers associated with the first through third sets of speech samples 202a-206a. For example, the first set of speaker IDs 202d includes speaker IDs of the first set of speakers 116. Similarly, the second and third sets of speaker IDs 204d and 206d include speaker IDs of the second and third sets of speakers 118 and 120, respectively. The speaker ID of each speaker may be a unique identifier that is representative of speaking characteristics of a corresponding speaker. The speaking characteristics of each speaker may be indicative of features that are unique to each speaker pitch, spectrum of speech, spectral envelope, or the like. The speaker ID of each speaker, of the first through third sets of speakers 116-120, may be maintained or stored in the speaker lexicon 124 in the database server 102. For example, if the first through third sets of speakers 116-120, each includes 100 speakers, the speaker lexicon 124 stores 300 speaker IDs, each of which is representative of the set of speaking characteristics of the corresponding speaker.

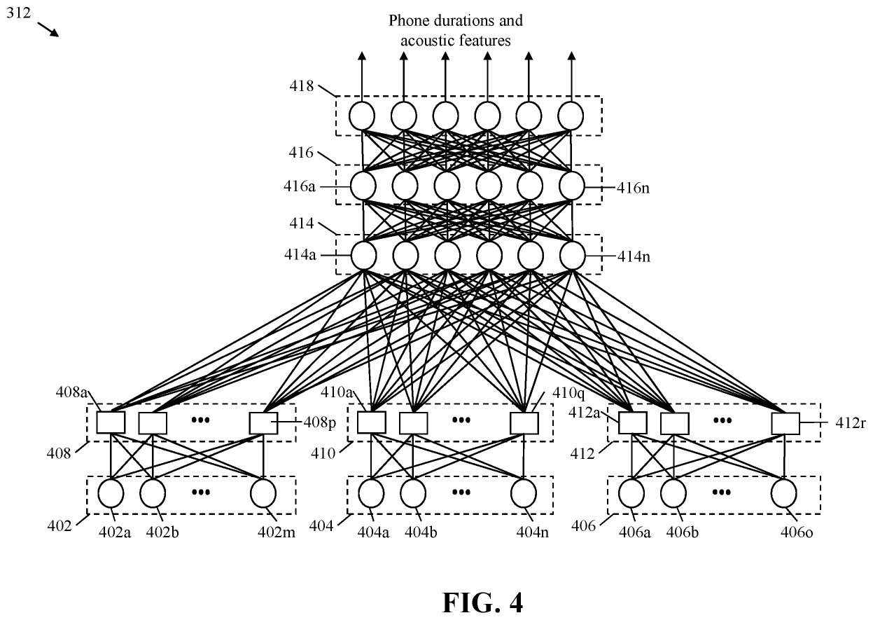

Each of the first through third training datasets 110-114 may further include vectors representative of the first through third sets of phonetic transcriptions 202b-206b, the first through third sets of prosodic annotations 202c-206c, and the first through third sets of speaker IDs 202d-206d. For example, the first through third training datasets 110-114 may include a first set of vectors corresponding to the phonetic inventory 122 and the first through third sets of phonetic transcriptions 202b-206b. The first through third training datasets 110-114 may further include a second set of vectors corresponding to the first through third sets of prosodic annotations 202c-206c. The first through third training datasets 110-114 may further include a third set of vectors corresponding to the first through third sets of speaker IDs 202d-206d. The first through third sets of vectors are explained in conjunction with FIG. 4.

Referring back to FIG. 1, the training server 104 is a neural network-basedtext-to-speech (TTS) system which includes suitable logic, circuitry, interface, and code, executable by the circuitry, for training the neural network to synthesize cross-lingual speech. The training server 104 may be configured to receive, from the database server 102, the first through third training datasets 110-114 and train the neural network based on the received first through third training datasets 110-114 (i.e., based on the first through third sets of vectors), for synthesizing or producing cross-lingual speech. The first through third training datasets 110-114 constitute training corpora for training the neural network. The training server 104 communicates, to the synthesis server 106, a local version of the trained neural network.

The synthesis server 106 is a neural network-based text-to-speech (TTS) system which includes suitable logic, circuitry, interface, and code, executable by the circuitry, for synthesizing cross-lingual speech, using the local version of the trained neural network. The synthesis server 106 utilizes the local version of the trained neural network to synthesize speech in a voice of any speaker (e.g., any of the first through third sets of speakers 116-120) in any language (e.g., any of the first through third languages). In other words, the synthesis server 106 synthesizes (i.e., produce) speech that corresponds to a speaker-language combination not included (i.e., cross-lingual) in any of the first through third sets of speech samples 202a-206a. For example, the synthesis server 106 may synthesize speech in a voice of the first speaker, included in the first set of speakers 116 associated with American English, in Mexican Spanish or Castilian Spanish, even though no speech sample of the first speaker speaking in Mexican Spanish or Castilian Spanish exists in any of the first through third sets of speech samples 202a-206a. In some embodiments, the synthesis server 106 may synthesize speech in more than one language. For example, the synthesis server 106 may synthesize speech in a voice of the first speaker, included in the first set of speakers 116 associated with American English, in Mexican Spanish or Castilian Spanish or both, even though no speech sample of the first speaker speaking in Mexican Spanish or Castilian Spanish exists in any of the first through third sets of speech samples 202a-206a.

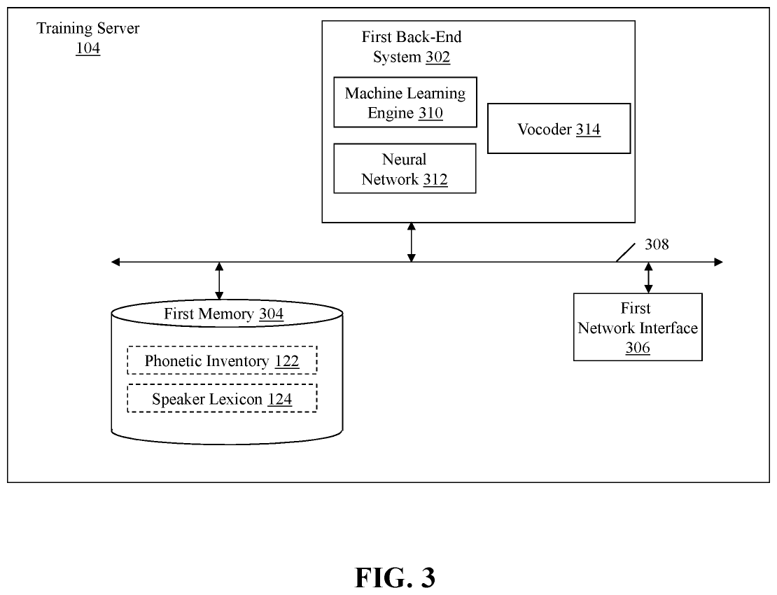

In operation, the training server 104 receives the first through third training datasets 110-114, the phonetic inventory 122, and the speaker lexicon 124 from the database server 102. The training server 104 may include, therein, a first back-end system. The first back-end system is built or trained based on the received first through third training datasets 110-114. The first back-end system that includes the neural network is trained to learn phonemes and prosodic features of each language (e.g., American English, Mexican Spanish, and Castilian Spanish) associated with the first through third sets of speech samples 202a-206a. The neural network is trained to learn speaking characteristics of each speaker of the first through third sets of speakers 116-120. In other words, the neural network learns abstract representations of phonemes and prosodic features of each language and speaking characteristics of each speaker. The neural network is trained to determine phone durations and acoustic features for synthesizing speech in any speaker-language combination (i.e., cross-lingual). The training server 104 communicates, to the synthesis server 106, the local version of the trained neural network. The structure and functionality of the training server 104 is explained in conjunction with FIG. 3.

The synthesis server 106 stores, therein, the local version of the trained neural network. The synthesis server 106 may receive, from a device or a server, a first request for speech synthesis. The received first request may include a target text document and may be indicative of a target language (i.e., any of the first through third languages) and a speaker ID of a target speaker. In some embodiments, the received first request may include a target text document and may be indicative of a plurality of target languages. As an example, the received first request may include a target text document and may be indicative of both English and Castilian Spanish as target languages. The received first request is a request for reading out the target text document in the target language in the voice of the target speaker. In one embodiment, the target text document may be in the target language. For example, the target text document and the target language may both correspond to Castilian Spanish. In some embodiments, the target text document may be in a first language that is different from the target language. For example, the target text document may be in Castilian Spanish and the target language may be English. In some embodiments, the target text document may be in a plurality of languages, and at least one of the plurality of languages is different from the target language. As an example, the target text document may be in English and Castilian Spanish and the target language may be English. The synthesis server 106 may include, therein, a front-end system and a second back-end system. The front-end system may disambiguate the target text document, for example, converting the numbers in the target text document to words. The front-end system, based on the phonetic inventory 122, generates a phonetic transcription of the (disambiguated) target text document. The phonetic transcription of the target text document is generated based on phonemes that correspond to the target language. In some embodiments, the target text document may be in a plurality of languages, and the front-end system, based on the phonetic inventory 122, may generate a phonetic transcription of respective parts of the target text document in the respective languages from the plurality of languages. For example, the target text document may be in English and Castilian Spanish, then a phonetic transcription of the respective text in the target document in English is in English and the respective text in the target document in Castilian Spanish is in Castilian Spanish. For example, a sentence: “Street name is: ‘Barriada La Carabina’” may be phonetized (by the front-end system) into English phonemes for the part “Street name is” and into Spanish phonemes for the rest of the sentence. All of the phonemes (English and Spanish) will be fed into the neural network and the sentence will be synthesized by using appropriate language (phonemes and accents) for each part of the sentence. In some embodiments, even more languages may be used in a single sentence. In this case, another module preprocesses the sentence and to provide appropriate phonemes and prosodic tags. The front-end system further generates a prosodic annotation of the (disambiguated) target text document. The generated prosodic annotation should include a set of abstract prosody tags that are indicative of a set of language-specific, speaker- agnostic prosodic features, predicted by the front-end system, based on the target text document. In some embodiments, the target text document may be in a plurality of languages, and the front-end system may generate a prosodic annotation of respective parts of the target text document in their respective language from the plurality of languages. For example, the target text document may be in English and Castilian Spanish, then a prosodic annotation of the respective text in the target document in English is in English and the respective text in the target document in Castilian Spanish is in Castilian Spanish. The front-end system further generates a set of vectors indicative of phonemes in the generated phonetic transcription, another set of vectors based on the generated prosodic annotation of target text document, and a vector that is indicative of the speaker ID of the target speaker.

The front-end system provides these generated vectors to the second back-end system. The second back-end system provides these vectors, generated by the front-end system, to the trained neural network as input. Based on the input, the trained neural network determines or generates, as output, a set of phone durations and a set of acoustic features (e.g., fundamental frequency, mel-spectrogram, spectral envelope, or the like). The set of phone durations and the set of acoustic features may be provided as input to a vocoder (i.e., voice encoder) for synthesizing a waveform for a speech signal. The vocoder generates the waveform that corresponds to an audio of the speech sample, included in the received first request. The translated audio is in the target in the target language in the voice of the target speaker. The synthesis server 106 may communicate the generated waveform to the device or a server from which the first request is received. The structure and functionality of the synthesis server 106 is explained in conjunction with FIG. 4.

In another embodiment, the first through third training datasets 110-114 may include only the first through third sets of speech samples 202a-206a. In such a scenario, the training server 104 may automatically generate the first through third sets of phonetic transcriptions 202b-206b, the first through third sets of prosodic annotations 202c-206c, or the first through third sets of speaker IDs 202d-206d, based on the first through third training datasets 110-114 received from the database server 102. The training server 104 may further generate the phonetic inventory 122 and the speaker lexicon 124, based on the first through third training datasets 110-114 received from the database server 102.

In another embodiment, the first through third training datasets 110-114 may include only the first through third sets of speech samples 202a-206a. In such a scenario, the training server 104 may automatically generate the first through third sets of phonetic transcriptions 202b-206b, the first through third sets of prosodic annotations 202c-206c, or the first through third sets of speaker IDs 202d-206d, based on the first through third training datasets 110-114 received from the database server 102. The training server 104 may further generate the phonetic inventory 122 and the speaker lexicon 124, based on the first through third training datasets 110-114 received from the database server 102.

In another embodiment, the target text document, included in the received first request, may be in a language different from the target language indicated by the received first request. In such a scenario, the synthesis server 106 may translate the target text document to the target language. The synthesis server 106 may generate a phonetic transcription of the translated target text document based on phonemes corresponding to the target language. The synthesis server 106 may further generate a prosodic annotation indicative of language-specific, speaker-agnostic prosodic features of the target language. Remaining steps for synthesizing cross-lingual speech, based on the received first request, are similar to process mentioned above. Since the information of phonetic transcriptions, prosodic annotations, and voice-related speaker specific features is separated, phonetic transcriptions, prosodic annotations, and voice-related speaker specific features may be used in different combinations. Using them in different combinations enables speech synthesis in the voice of a speaker who isn't present in the training data speaking the target language. Thus, embodiments of the present disclosure may be used to synthesize speech in a specific speaker's voice in a language that the speaker has never spoken.

In another embodiment, the received first request may include a target speech sample, instead of the target text document. In such a scenario, the synthesis server 106 may generate a textual representation of the target speech sample. The synthesis server 106 may translate the generated textual representation to the target language, depending on whether the textual representation is in a language different from the target language. The synthesis server 106 may further generate a phonetic transcription of the generated textual representation, of the target speech sample, based on phonemes corresponding to the target language. The synthesis server 106 may further generate, based on the generated phonetic transcription and the target speech sample, a prosodic annotation indicative of language-specific, speaker-agnostic prosodic features of the target language. Remaining steps for synthesizing cross-lingual speech, based on the received first request, is similar to process mentioned above.

The synthesis server 106 may be used to synthesize cross-lingual speech in various application areas. In one embodiment, the synthesis server 106 may be utilized by voice assistants (e.g., Alexa, Cortana, Siri, or the like) as a TTS system for synthesizing speech in any language and in a voice of any speaker (e.g., a famous celebrity). In another embodiment, the synthesis server 106 may be utilized by a navigation system running on a device (e.g., a smartphone, a phablet, a laptop, a personal computer, or a smartwatch) of an individual for providing turn-by-turn instructions in a language and a voice (e.g., the famous celebrity) that are preferred by the individual. In another embodiment, the synthesis server 106 may be used to generate a dubbed version of a movie show or a television series, based on speech samples of voice-actors in an original version of the movie show or the television series. In another embodiment, the synthesis server 106 may be used to generate audio books in a voice (e.g., the famous celebrity) of a preferred individual. In another embodiment, the synthesis server 106 may be employed as a constituent component of a larger system for real-time (or quasi real-time) speech generation. For example, the synthesis server 106 may be used in systems aimed at translating speech (e.g., a phone conversation) generated by a speaker in a first language, to a second language while retaining the voice of the speaker.

In another embodiment, the synthesis server 106 may be used to correct accents, in real-time or quasi real-time, in speech. For example, the database server 102 may include another training dataset that includes speech samples of Indian speakers speaking Indian-accented English.

The other training dataset may further include corresponding set of phonetic transcriptions, corresponding set of prosodic annotations, and corresponding set of speaker IDs. The training server 104 may train the neural network to learn phonemes of Indian-accented English and language-specific, speaker-agnostic features of Indian-accented English. The training server 104 may also train the neural network to learn speaking characteristics of the Indian speakers. The synthesis server 106 may receive a request for speech synthesis that includes a target text document and a speaker ID of the target speaker (i.e., one of the Indian speakers). Based on the received request, the synthesis server 106 generates speech in American English in a voice of the Indian speaker. In some scenarios, the received request may include, instead of the target text document, a speech sample in a voice of an Indian speaker in Indian-accented English. The synthesis server 106, in such scenarios, generates a textual representation of the speech sample using automatic speech recognition. The synthesis server 106 generates or predicts, based on the generated textual representation and/or the speech sample, a phonetic transcription and a set of language-specific, speaker agnostic prosodic features. The synthesis server 106 synthesizes, based on the phonetic transcription and the set of language-specific, speaker agnostic prosodic features, speech in the voice of the Indian speaker, but in an American English accent. Similarly, accent of a speaker of American English (e.g., an American celebrity) may be modified to an Indian accent. The synthesis server 106 may be used to modify accents of various speakers without any language translation.

In some embodiments, functionality of the training server 104 and that of the synthesis server 106 may be integrated into a single server. The single server may perform, both, training of the neural network and synthesis of cross-lingual speech.

FIG. 3 is a block diagram that represents the training server 104, in accordance with an exemplary embodiment of the present disclosure. The training server 104 includes the first back-end system (hereinafter, referred to as “the first back-end system 302”), a first memory 304, and a first network interface 306. The first back-end system 302, the first memory 304, and the first network interface 306 may communicate with each other by way of a first communication bus 308. The first back-end system 302 may include a machine learning engine 310, the neural network (hereinafter, referred to as “the neural network 312”), and a vocoder 314.

The first back-end system 302 includes suitable logic, circuitry, interfaces, and/or code for executing a set of instructions stored in a suitable data storage device (for example, the first memory 304) for synthesizing cross-lingual speech. Examples of the first back-end system 302 include, but are not limited to, an application-specific integrated circuit (ASIC) processor, a reduced instruction set computer (RISC) processor, a complex instruction set computer (CISC) processor, a field programmable gate array (FPGA), a central processing unit (CPU), a graphics processing unit (GPU), or the like. The first back-end system 302 may execute various operations for training the neural network 312.

The machine learning engine 310 may include processing circuitry (e.g., a processor) that may be configured to receive inputs, from the database server 102, and build and/or train the neural network 312 based on the received inputs. The received inputs include the first through third sets of vectors, the first through third sets of speech samples 202a-206a, the first through third sets of phonetic transcriptions 202b-206b, the first through third sets of prosodic annotations 202c-206c, and the first through third sets of speaker IDs 202d-206d. The machine learning engine 310 may build and/or train the neural network 312, using various deep learning frameworks such as, but not limited to, TensorFlow, Keras, PyTorch, Caffe, Deeplearning4j, Microsoft Cognitive Tool Kit, MXNet, or the like.

The neural network 312 is a machine learning model that is trained to determine phone durations and acoustic features for generating speech in any speaker-language combination. The neural network 312 may conform to various architectures such as, but not limited to, a convolution neural network (CNN), a deep neural network (DNN), a recurrent neural network (RNN), a Long Short Term Memory networks (LSTM) network, a bidirectional LSTM network, sequence-to-sequence model, bidirectional recurrency, residual connections, variational encoders, generative adversarial networks, or a combination thereof. The first through third training datasets 110-114 constitute training corpora for training the neural network 312. For the sake brevity, in the current embodiment, a single neural network (i.e., the neural network 312) is used for determination (i.e., prediction) of both phone durations and acoustic features. However, in another embodiment, separate neural networks may be used for determination of phone durations and acoustic features.

The vocoder 314 may be one of deterministic vocoders (e.g., WORLD vocoder) or neural vocoders (e.g., WaveNet, WaveGlow, WaveRNN, ClariNet, or the like) that generate a waveform of a speech signal, based on the set of phone durations and the set of acoustic features determined by the neural network 312. When the vocoder 314 is a neural vocoder, the vocoder 314 may generate a set of speaker embeddings, based on the first through third sets of speaker IDs 202d-206d and the speaker lexicon 124 that are received from the database server 102. The vocoder 314 is trained to generate waveforms for speech signals based on phone durations and acoustic features.

The first memory 304 includes suitable logic, circuitry, and/or interfaces for storing the phonetic inventory 122 and the speaker lexicon 124 received from the database server 102. Examples of the first memory 304 may include a random-access memory (RAM), a read-only memory (ROM), a removable storage drive, a hard disk drive (HDD), a flash memory, a solid-state memory, and the like. It will be apparent to a person skilled in the art that the scope of the disclosure is not limited to realizing the first memory 304 in the training server 104, as described herein. In another embodiment, the first memory 304 may be realized in form of a database server or a cloud storage working in conjunction with the training server 104, without departing from the scope of the disclosure.

The first network interface 306 may include suitable logic, circuitry, interfaces, and/or code, executable by the circuitry, to transmit and receive data over the communication network 108 using one or more communication network protocols. The first network interface 306 may receive messages (e.g., the first through third training datasets 110-114) from the database server 102. The first network interface 306 may further receive, from various devices or servers, requests for speech synthesis. Further, the first network interface 306 transmits messages or information (e.g., the trained neural network 312, the trained vocoder 314, the phonetic inventory 122, and the speaker lexicon 124) to the synthesis server 106. Examples of the first network interface 306 may include, but are not limited to, an antenna, a radio frequency transceiver, a wireless transceiver, a Bluetooth transceiver, an ethernet port, or any other device configured to transmit and receive data.

FIG. 4 is a block diagram that illustrates the training of the neural network 312, in accordance with an exemplary embodiment of the present disclosure. FIG. 4 is described in conjunction with FIGS. 1, 2, and 3.

As described in the foregoing description of FIG. 1, the first back-end system 302 receives, from the database server 102, the first through third training datasets 110-114 that include the first through third sets of vectors. Hereinafter, the first through third sets of vectors are referred to as “the first through third sets of vectors 402-406”. The first set of vectors 402 is based on the phonetic inventory 122 and the first through third sets of phonetic transcriptions 202b-206b. For example, based on each phonetic transcription of the first through third sets of phonetic transcriptions 202b-206b, a one-hot vector corresponding to each phoneme in a corresponding phonetic transcription is generated. For example, the one-hot vector is a binary vector (e.g., a column matrix or a row matrix) with length same as that of a number of phonemes (i.e., “94”) in the phonetic inventory 122. Typically, in a one-hot vector, all elements barring a single element are equal to zero. The single element may be “1”, which is in the place where a phoneme appears in the phonetic inventory 122. For example, if a phoneme “b”, of American English, occupies a first position in the phonetic inventory 122, the one-hot vector for the phoneme “b” is a row matrix with 94 columns having all zeroes except at first element, which equals “1”. Similarly, if a phoneme “æ”, of American English, occupies a twenty-fifth position in the phonetic inventory 122, the one-hot vector for the phoneme “æ” is a row matrix with 94 columns having all zeroes except at twenty-fifth element, which equals “1”. The first set of vectors 402 includes first through m^{th} one-hot vectors 402a-402m for representing phonemes. The first set of vectors 402 includes a one-hot vector for each phoneme in each speech sample of the first through third sets of speech samples 202a-206a.

The second set of vectors 404 is generated based on the prosodic features (i.e., language-specific, speaker-agnostic prosodic features) of each speech sample of the first through third sets of speech samples 202a-206a. In a non-limiting example, the second set of vectors 404 may not be one-hot vectors. Each vector, of the second set of vectors 404, may be indicative of prosodic features (i.e., prosodic events) corresponding to each syllable or word in each phonetic transcription of the first through third sets of phonetic transcriptions 202b-206b of the first through third sets of speech samples 202a-206a. In a non-limiting example, each vector, of the second set of vectors 404, indicates prosodic features representing answers to binary questions, such as, but not limited to, “Is the current phoneme a stressed syllable?”, “Is a number of syllables until a next phase break greater than a threshold (e.g., 3)?”, or the like. In another non-limiting example, each vector, of the second set of vectors 404, indicates prosodic features representing absolute values corresponding to a level of stress on each phoneme, a number of syllables until a phase break, or the like. The second set of vectors 404 includes first through n^{th} vectors 404a-404n for representing prosodic features.

Similarly, the third set of vectors 406 is a set of one-hot vectors generated based on the speaker lexicon 124 that stores the speaker ID and the set of speaking characteristics of each speaker of the first through third sets of speakers 116-120. Each vector of the third set of vectors 406 is a binary vector with a length same as that of a number (e.g., 300) of speaker IDs stored in the speaker lexicon 124. For example, if a speaker ID of a speaker, occupies a first position in the speaker lexicon 124, the one-hot vector for a corresponding speaker is a row matrix with 300 columns having all zeroes except at first element, which equals “1”. Thus, the third set of vectors 406 includes a one-hot vector for each speaker in the first through third sets of speakers 116-120. The third set of vectors 406 includes first through o^{th} one-hot vectors 406a-406o for representing each speaker of the first through third sets of speakers 116-120.

Based on the first through third sets of vectors 402-406, the neural network 312 generates a set of phoneme embeddings 408, a set of prosody embeddings 410, and a set of speaker embeddings 412. In other words, the neural network 312 creates a phoneme embedding space, a prosody embedding space, and a speaker embedding space. An embedding space is a low-dimensional space into which high-dimensional vectors (e.g., each vector of the first through third sets of vectors 402-406) are mapped for reducing computational complexity. In other words, an embedding is a mapping of high-dimensional vectors into a relatively low-dimensional space, established so as to make it easier for the neural network 312 to generalize on sparse data such as high-dimensional vectors (e.g., the first through third sets of vectors 402-406) typically used in speech synthesis (representing phonemes, speakers, prosody, or the like).

Embeddings establish logical relationships between input features by mapping similar inputs to points that are close together in the embedding space. For example, the set of phoneme embeddings 408 may be represented as points in a d-dimensional space (e.g., d=3, 5, 20, or the like). Sizes of the phoneme embedding space and the speaker embeddings may be related to a size of the phonetic inventory 122 and a number of speakers in the speaker lexicon 124, respectively. Embeddings of phonemes that are the same will occupy the same point in the d-dimensional space. Embeddings of phonemes that are similar are expected to occupy close points in the d-dimensional space. Phonemes from each of the first through third sets of languages are treated as separate, such that each phoneme is uniquely represented by a one-hot vector. These phonemes are embedded in the d-dimensional embedding space for the neural network 312 to define a point in the d-dimensional embedding space for each phoneme. Consequently, the neural network 312 determines a degree to which two phonemes (e.g. the American English “ [symbol] ” and the French “ [symbol] ”) are similar. IPA may consider these similar phonemes to be the same; however, there may still be variations between the phonemes on the phonetic level. In a non-limiting example, the set of phoneme embeddings 408 includes first through p^{th} phoneme embeddings 408a-408p, such that p«m. Similarly, the set of prosody embeddings 410 includes first through q^{th} prosody embeddings 410a-410q such that q«n. Syllables and words with similar prosodic features are represented as close points in the d-dimensional space. Similarly, the set of speaker embeddings 412 includes first through r^{th} speaker embeddings 412a-412r such that r«o. Speakers with similar sets of speaking characteristics are expected to occupy close points in the d-dimensional space. The set of phoneme embeddings 408, the set of prosody embeddings 410, and the set of speaker embeddings 412 collectively constitute an input layer of the neural network 312.

Generation of the set of prosody embeddings 410 is not necessary if same annotation scheme is used for annotation of the first through third sets of speech samples 202a-206a. However, if different annotation schemes are used for annotation of the first through third sets of speech samples 202a-206a, the set of prosody embeddings 410 will represent a mapping of prosodic features of the first through third languages, into a space of lower dimensionality shared across the first through third languages, enabling synthesis of cross-lingual speech.

The neural network 312 includes the input layer that includes the set of phoneme embeddings 408, the set of prosody embeddings 410, and the set of speaker embeddings 412, a set of hidden layers (e.g., first and second hidden layers 414 and 416) and an output layer 418. The first and second hidden layers 414 and 416 each include first through n^{th} neurons 414a-414n and 416a-416n. For the sake of brevity, the neural network 312 is shown to include only two hidden layers (i.e., the first and second hidden layers 414 and 416). However, it will be apparent to those of ordinary skill in the art that the neural network 312 may include any number of hidden layers without deviating from the scope of the disclosure. The machine learning engine 310 employs machine learning algorithms, such as supervised, unsupervised, semi-supervised, or reinforcement machine learning algorithms for training the neural network 312. Typically, the machine learning algorithms refer to a category of algorithms employed by a system that allows the system to become more accurate in predicting outcomes and/or performing tasks, without being explicitly programmed. The neural network 312 may be trained using various techniques such as back-propagation technique. The neural network 312 is trained to learn phonemes in each of the first through third languages, language-specific, speaker-agnostic prosodic features of each of the first third languages, and speaking characteristics of each speaker of the first through third sets of speakers 116-120.

The neural network 312 may be re-trained, whenever new speech samples are stored by the database server 102 and are received by the training server 104. The new speech samples may correspond to speech samples of existing speakers (i.e., any speaker of the first through third sets of speakers 116-120), new speakers, existing languages (i.e., the first through third languages), new languages, or a combination thereof. When a new speech sample is introduced in the database server 102, the database server 102 may communicate to the training server 104, a phonetic transcription and a prosodic annotation corresponding to the new speech sample. The database server 102 may further communicate to the training server 104, a speaker ID of a speaker of the new speech sample. If the speech sample corresponds to a new language, the database server 102 may update the phonetic inventory 122 to include phonemes corresponding to the new language. If the speech sample is from a new speaker (i.e., speaker not included in any of the first through third sets of speakers 116-120), the database server 102 may update the speaker lexicon 124 to include the new speaker. The updated speaker lexicon 124 includes a speaker ID of the new speaker. The updated speaker lexicon 124 may further include a set of speaking characteristics of the new speaker. The database server 102 may further communicate to the training server 104 the updated phonetic inventory 122 or the updated speaker lexicon 124, if the speech sample corresponds to a new language (e.g., Indian-accented English, French, or the like) or a new speaker. The training server 104 may re-train the neural network 312, based on the first through third training datasets 110-114, and the phonetic transcription, the speaker ID, and the prosodic annotation corresponding to the new speech sample. The training server 104 may communicate, to the synthesis server 106, the re-trained neural network 312.

In one embodiment, when the new speech sample corresponds to a new user and one of the first through third languages, the neural network 312 may be re-trained in two stages. In a first stage, the neural network 312 may determine a suitable point in the speaker embedding space for the speaker ID of the new speaker. In the second stage, the rest of the neural network 312 (i.e., the set of phoneme embeddings 408, the set of prosody embeddings 410, and the first and second hidden layers 414 and 416) may be fine-tuned using the phonetic transcription and the prosodic annotation corresponding to the new speech sample. Alternatively, the neural network 312 may be used as is with the speaker ID of the new speaker. The neural network 312 is able to determine phone durations and acoustic features corresponding the voice of the new speaker in any of the first through third languages.

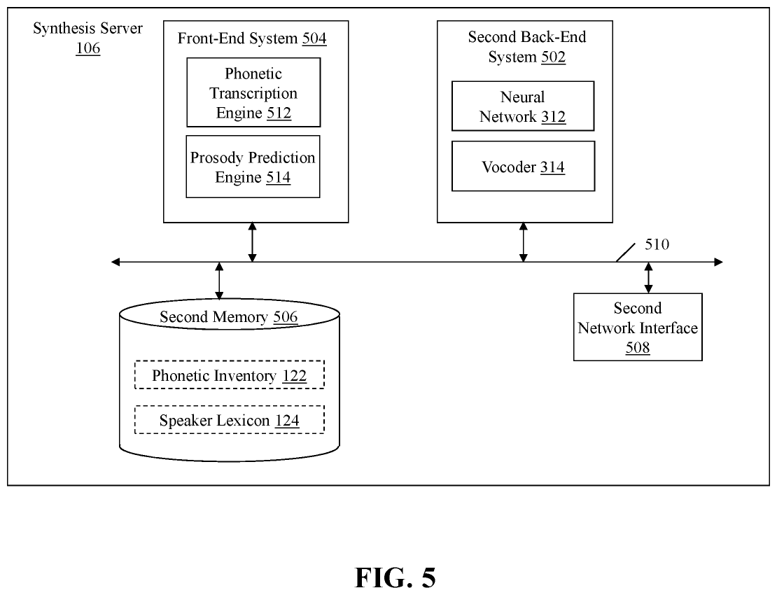

FIG. 5 is a block diagram that represents the synthesis server 106, in accordance with an exemplary embodiment of the present disclosure. The synthesis server 106 includes the second back-end system (hereinafter, referred to as “the second back-end system 502”) and the front-end system (hereinafter, referred to as “the front-end system 504”) a second memory 506, and a second network interface 508. The second back-end system 502, the front-end system 504, the second memory 506, and the second network interface 508 may communicate with each other by way of a second communication bus 510. The second back-end system 502 may include the trained neural network 312 and the vocoder 314. The second back-end system 502 receives from, the training server 104, the trained neural network 312 and the trained vocoder 314.

The second back-end system 502 includes suitable logic, circuitry, interfaces, and/or code for executing a set of instructions stored in a suitable data storage device (for example, the second memory 506) for synthesizing cross-lingual speech using. Examples of the second back-end system 502 include, but are not limited to, an ASIC processor, a RISC processor, a CISC processor, an FPGA, a CPU, a GPU, or the like. The second back-end system 502 may execute various operations for synthesizing speech, using the local version of the trained neural network 312 and the trained vocoder 314.

The front-end system 504 includes suitable logic, circuitry, interfaces, and/or code for executing a set of instructions stored in a suitable data storage device (for example, the second memory 506) for generating phonetic transcriptions and prosodic annotations of target text documents included in received requests. Examples of the front-end system 504 may include, but are not limited to, an ASIC processor, a RISC processor, a CISC processor, an FPGA, a CPU, or the like. The front-end system 504 may execute various operations for generating phonetic transcriptions and prosodic annotations of target text documents by way of a phonetic transcription engine 512 and a prosody prediction engine 514.

The phonetic transcription engine 512 generates phonetic transcriptions for target text documents included in requests for speech synthesis received by the synthesis server 106. For the text document included in the first request received by the synthesis server 106, the phonetic transcription engine 512 generates the phonetic transcription using phonemes corresponding to the language of the text document. For example, if the target text document is in Castilian Spanish, the generated phonetic transcription is composed of phonemes that correspond to Castilian Spanish.

The prosody prediction engine 514 is configured to predict prosodic features for speech that is to be synthesized based on the received requests. The prosody prediction engine 514 predicts language-specific, speaker-agnostic prosodic features for speech that is to be generated based on the target text document that is included in the first request received by the synthesis server 106. In other words, the prosody prediction engine 514 generates a prosodic annotation for the target text document, such that the generated prosodic annotation is indicative of language-specific, speaker-agnostic prosodic features of speech that is to be synthesized based on the target text document. The prosody prediction engine 514 may use the one or more annotation schemes (e.g., ToBI, IViE, Sp_TOBI, or the like) for the generation of the prosodic annotation for the target text document. The prosody prediction engine 514 may be of various types, such as, a neural-network type, a rules-based type, or the like.

In some embodiments, the generated phonetic transcription and the generated prosodic annotation of the target text document may be modified manually (i.e., manual override) by a user based on one or more requirements for the synthesis of the cross-lingual speech.

The second memory 506 includes suitable logic, circuitry, and/or interfaces for storing the phonetic inventory 122 and the speaker lexicon 124, received from the training server 104. Examples of the second memory 506 may include a random-access memory (RAM), a read-only memory (ROM), a removable storage drive, a hard disk drive (HDD), a flash memory, a solid-state memory, and the like. It will be apparent to a person skilled in the art that the scope of the disclosure is not limited to realizing the second memory 506 in the synthesis server 106, as described herein. In another embodiment, the second memory 506 may be realized in form of a database server or a cloud storage working in conjunction with the synthesis server 106, without departing from the scope of the disclosure.

The second network interface 508 may include suitable logic, circuitry, interfaces, and/or code, executable by the circuitry, to transmit and receive data over the communication network 108 using one or more communication network protocols. The second network interface 508 may receive, from various devices or servers, requests for speech synthesis. Further, the second network interface 508 may transmit messages (e.g., the generated waveform) to the various devices or servers. Examples of the second network interface 508 may include, but are not limited to, an antenna, a radio frequency transceiver, a wireless transceiver, a Bluetooth transceiver, an ethernet port, or any other device configured to transmit and receive data.

In some embodiments, the synthesis server 106 may further include an automatic speech recognizer The automatic speech recognizer may be configured to generate textual representations of speech samples included in requests for cross-lingual speech synthesis received by the synthesis server 106. If the first request includes the target speech sample, instead of the target text document, the automatic speech recognizer generates a textual representation of the target speech sample. The automatic speech recognizer may provide the generated textual representation to the front-end system 504 for generation of a phonetic transcription and a prosodic annotation of the generated textual representation. In some embodiments, the synthesis server 106 may further include a language translation engine that may be configured to translate the target text document, included in the first request, to the target language if the language of the target text document is different from the target language. Following the translation, the language translation engine may provide the translated target text document to the front-end system 504 for generation of a prosodic annotation and a phonetic transcription of the translated target text document.

Following a completion of the training phase (i.e., during a synthesis phase), the training server 104 communicates the local version of the trained neural network 312 to the synthesis server 106. In a non-limiting example, the training server 104 may communicate, to the synthesis server 106, weights of links between the input layer and the first hidden layer 414, weights of links between the first hidden layer 414 and the second hidden layer 416, weights of links between the second hidden layer 416 and the output layer 418. Using the weights of links between various layers of the trained neural network 312, the local version of the trained neural network 312 may be realized in the synthesis server 106. Similarly, the training server 104 communicates the trained vocoder 314 to the synthesis server 106.

The synthesis server 106 may receive the first request for speech synthesis. The received first request includes the target text document and the speaker ID of the target speaker. In a non-limiting example, the target text document is in the target language (i.e., one of the first through third languages). As described in the foregoing descriptions of FIG. 1, the front-end system 504 generates the phonetic transcription, the prosodic annotation of the target text document. The front-end system 504 further generates a set of vectors indicative of the phonemes in phonetic transcription of the target text document. Similar to the first set of vectors 402, each vector of this set of vectors is a one-hot vector indicative of a phoneme in the phonetic transcription of the target text document. The front-end system 504 may further generate another set of vectors corresponding to the prosodic annotation, of the target text document, generated by the prosody prediction engine 514. Similar to the second set of vectors 404, this set of vectors is indicative of language-specific, speaker-agnostic prosodic features of the target text-document. The front-end system 504 may further generate another vector, which is a one-hot vector corresponding to the speaker ID of the target speaker. These vectors are provided to the neural network 312 as input. The target language is identified, by the neural network 312, based on the phonemes and prosodic features as indicated by the vectors inputted to the neural network 312. Based on input, the neural network 312 determines a set of phone durations and a set of acoustic features for generating speech in the target language (i.e., Castilian Spanish) in the voice of the target speaker (i.e., the first speaker).

The determined set of phone durations and the set of acoustic features may be provided as input to the local version of the trained vocoder 314 for generation of a corresponding waveform. The determined set of acoustic characteristics reflects speaking characteristics of the speaker (i.e., the target speaker) corresponding to the speaker ID. The machine learning engine 310 may further provide, to the vocoder 314, the speaker ID of the target speaker. The vocoder 314 generates the waveform based on the set of phone durations, the set of acoustic features, and the speaker ID of the target speaker. In one embodiment, the generation of the waveform is conditioned by the vocoder 314, using the set of speaker embeddings generated by the vocoder 314 (i.e., the set of speaker embeddings generated during the training of the neural vocoder 314) based on the first through third sets of speaker IDs 202d-206d. In another embodiment, the generated waveform may be conditioned by the vocoder 314, using the set of speaker embeddings 412 generated by the neural network 312. Based on the speaker embedding corresponding to the target speaker ID and the acoustic features, the vocoder 314 generates a waveform that corresponds to natural sounding speech in the target language in the voice of the target speaker.

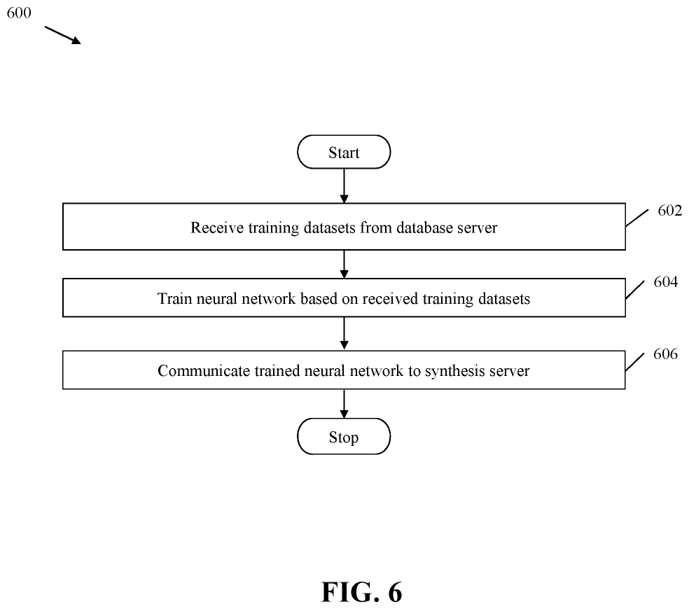

FIG. 6 represents a flowchart 600 that illustrates a method for training the neural network 312, in accordance with an exemplary embodiment of the present disclosure.

With reference to FIG. 6, at step 602, the training server 104 receives, from the database server 102, the first through third training datasets 110-114, the phonetic inventory 122, and the speaker lexicon 124. At step 604, the training server 104 trains the neural network 312 based on the received first through third training datasets 110-114 (i.e., the first through third sets of vectors 402-406), as described in the foregoing descriptions of FIGS. 1, 2, 3, and 4. At step 606, the training server 104 communicates the trained neural network 312, and the trained vocoder 314, to the synthesis server 106, as described in the foregoing description of FIG. 5.

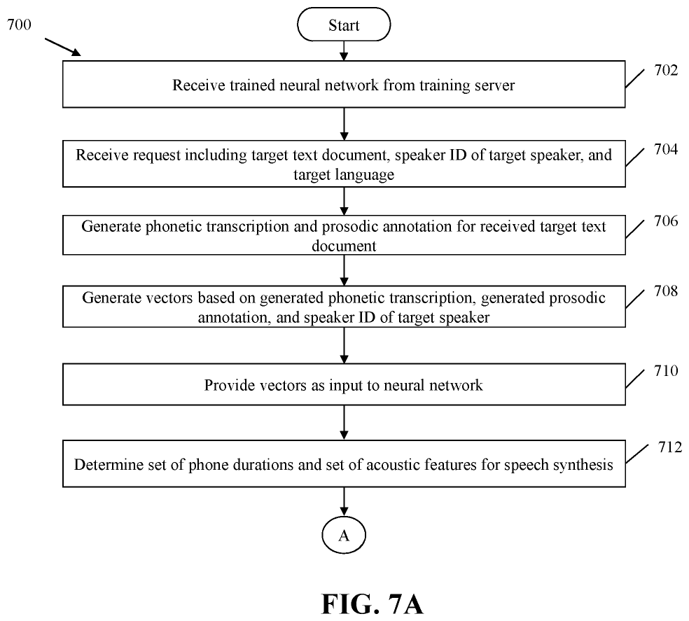

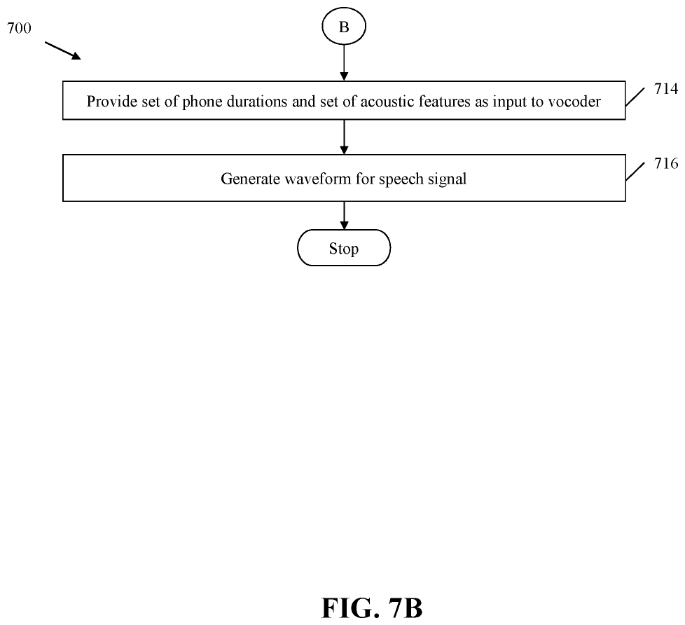

FIGS. 7A and 7B, collectively represent a flowchart 700 that illustrates a method for synthesizing cross-lingual speech, in accordance with an exemplary embodiment of the present disclosure.

With reference to FIG. 7A, at step 702, the synthesis server 106 receives the trained neural network 312, and the trained vocoder 314, from the training server 104. At step 704, the synthesis server 106 receives the first request for speech synthesis. The first request includes the target text document and the speaker ID of the target speaker. At step 706, the front-end system 504 generates the phonetic transcription and the prosodic annotation for the target text document included in the first request. At step 708, the front-end system 504 generates vectors based on the generated phonetic transcription, the generated prosodic annotation, and the speaker ID of the target speaker, respectively. The front-end system 504 provides these generated vectors to the second back-end system 502. At step 710, the second back-end system 502 provides these vectors, generated by the front-end system 504, to the trained neural network 312, as input. At step 712, the second back-end system 502 (i.e., the neural network 312) determines the set of phone durations and the set of acoustic features for generating cross-lingual speech in the target language in the voice of the target speaker.

With reference to FIG. 7B, at step 714, the set of phone durations and the set of acoustic features are provided as input to the vocoder 314 for generating a waveform for a requisite speech signal. At step 716, the vocoder 314 generates the waveform for the speech signal. The waveform corresponds to reading of the target text document in the target language in the voice of the target speaker. The generated waveform corresponds to natural sounding speech that conforms to the set of speaking characteristics of the target speaker and language-specific, speaker-agnostic prosodic features of the target language.

The environment 100 of FIG. 1 offers numerous advantages. The training server 104 does not require polyglot speakers (i.e., speakers with speech samples in multiple languages) in the first through third sets of speakers 116-120. As a consequence of training the neural network 312 based on the speaker ID of each speaker, of the first through third sets of speakers 116-120, and the language-specific, speaker-agnostic prosodic features of each speech sample of the first through third sets of speech samples 202a-206a, the synthesis server 106 generates speech in any speaker-language combination, irrespective of whether the speaker-language combination is included in the training corpora. The generated speech may conform to prosodic features of a corresponding language and a set of speaking characteristics (i.e., voice characteristics) of a corresponding speaker or speaker. A language of the generated speech corresponds to a phonetic transcription and a prosodic annotation of a target text document by the front-end system 504. If the target text document is multilingual, portions of the target text document be phonetically transcribed and prosodically annotated, by the front-end system 504, using corresponding phonemes and prosodic features, enabling synthesis of multilingual speech. Matching of phonemes across various languages (e.g., the first through third languages) does not require any manual effort, since similarity between phonemes of the various languages is determined by the neural network 312. Further, a small speech sample of a speaker is sufficient for generation of speech in any language in a voice of the speaker. Using large training datasets composed of large number of speech samples from a large number of speakers allows for synthesis of natural-sounding speech that is accurate in reproduction of speaking characteristics of a speaker and prosodic features of a corresponding speaker. The neural network 312 is robust to number of speech samples in each language (e.g., the first through third languages), enabling simpler extensions to new languages. Further, by using a common annotation scheme for speech samples of the first through third languages, training of the neural network 312 becomes easier and closer convergence of prosodic features of the through third languages is obtained. As a result of using the common annotation scheme (e.g., ToBI), new languages can be introduced with significantly less training speech data since the network has already learned from other languages how to map different combinations of prosodic tags into their acoustic correlates, and will be just fine-tuned with new data.

Various embodiments may be implemented as follows.

Implementation 1

According to a first implementation, a method for cross-lingual speech synthesis may include receiving, from a database server, training datasets that include a set of speech samples of a set of speakers in a set of languages; training a neural network to determine phone durations and acoustic features for cross-lingual speech synthesis, based on phonemes included in each speech sample, a speaker identifier (ID) of each speaker, and language-specific, speaker-agnostic prosodic features of each speech sample; receiving a request for synthesizing cross-lingual speech corresponding to a target text document in a target language, of the set of languages, in a voice of a target speaker, of the set of speakers; providing, as input to the neural network, phonemes included in the target text document, language-specific, speaker-agnostic prosodic features of the target text document, and an identifier of the target speaker; generating a set of phone durations and a set of acoustic features for synthesizing speech in the target language and the voice of the target speaker based on an output of the neural network; and generating, using a vocoder, a waveform for a speech signal corresponding to the target text document, the target language, and the voice of the target speaker based on the set of phone durations and the set of acoustic features, wherein speech is synthesized, in the target language and voice of the target speaker, based on the waveform generated by the vocoder.

Implementation 2

According to a second implementation, a method for cross-lingual speech synthesis may include receiving, from a database server, training datasets that include a set of speech samples of a set of speakers in a set of languages; training a neural network to determine phone durations and acoustic features for cross-lingual speech synthesis, based on phonemes included in each speech sample, a speaker identifier (ID) of each speaker, and language-specific, speaker-agnostic prosodic features of each speech sample; receiving a request for synthesizing cross-lingual speech corresponding to a target text document in a target language, of the set of languages, in a voice of a target speaker, of the set of speakers; providing, as input to the neural network, phonemes included in the target text document, language-specific, speaker-agnostic prosodic features of the target text document, and an identifier of the target speaker; generating a set of phone durations and a set of acoustic features for synthesizing speech in the target language and the voice of the target speaker based on an output of the neural network; generating, using a vocoder, a waveform for a speech signal corresponding to the target text document, the target language, and the voice of the target speaker based on the set of phone durations and the set of acoustic features; and synthesizing speech, in the target language and voice of the target speaker, based on the waveform generated by the vocoder.

Implementation 3

According to a third implementation, a method for cross-lingual speech synthesis may include receiving a request for synthesizing cross-lingual speech in a voice of a target speaker, the request including a target text document in a target language; inputting, to a cross-lingual neural network that has been trained to determine phone durations and acoustic features for cross-lingual speech synthesis, phonemes included in the target text document, prosodic features of the target text document, and an identifier of the target speaker; receiving, from the cross-lingual neural network, a set of phone durations and a set of acoustic features for synthesizing speech in the target language and in the voice of the target speaker; generating, using a vocoder, a waveform for a speech signal corresponding to the target text document, the target language, and the voice of the target speaker, based on the set of phone durations and the set of acoustic features; and synthesizing speech, in the target language and in voice of the target speaker, based on the waveform generated by the vocoder.

Implementation 4

In the method of implementation 3, the prosodic features may be language-specific and speaker-agnostic.

Implementation 5

In the method of implementation 3 or 4, the method may further include generating the cross-lingual neural network.

Implementation 6

In the method of any of the implementations 3-5, the generating the waveform may include receiving, from a database server, training datasets that include a set of speech samples of a set of speakers in a set of languages; and training the cross-lingual neural network to determine the phone durations and the acoustic features, based on phonemes included in each speech sample of the set of speech samples, a speaker identifier (ID) of each speaker of the set of speakers, and language-specific, speaker-agnostic prosodic features of each speech sample.

Implementation 7

In the method according to implementations 3-6, the target language may be included in the set of languages included in the training datasets and the target speaker may be included in the set of speakers included in the training datasets.

Implementation 8

According to an eighth implementation, a method for synthesizing cross-lingual speech may be executed by a processor and may include receiving a request for synthesizing speech, wherein the request for synthesizing speech comprises a target text document and a target language; generating phonetic transcriptions for the target text document; generating prosodic annotations for the target text document based on the target text document and the target language; generating phone durations and acoustic features based on the phonetic transcriptions and the prosodic annotations using a neural network; and synthesizing a speech corresponding to the target text document in the target language based on the generated phone durations and acoustic features.

Implementation 9

In the method of implementation 8, the target text document may be in a first language, and the target language may be different from the first language.

Implementation 10

In the method of implementations 8-9, prior to generating the phone durations and the acoustic features, the method may include receiving the neural network from a training server.

Implementation 11

In the method of implementations 8-10, the neural network may be trained using training data, wherein the training data comprises a plurality of speech samples in a plurality of languages, phonetic transcriptions corresponding to each of the plurality of speech samples, prosodic annotations corresponding to each of the plurality of speech samples, and speaker identifications (IDs) of speakers associated with the plurality of speech samples.

Implementation 12

In the method of implementations 8-11, the method may further comprise receiving a re-trained neural network from a training server, wherein the neural network is re-trained based on new training data.

Implementation 13

In the method of implementations 8-12, the request for synthesizing speech may further comprise a speaker ID for a target speaker, and wherein the synthesized speech is in a voice of the target speaker.

Implementation 14

In the method of implementations 8-14, the generating of the phone durations and the acoustic features may comprise generating a first set of vectors indicating phonemes in the phonetic transcriptions; generating a second set of vectors based on the prosodic annotations; inputting the first set of vectors and the second set of vectors into the neural network; and receiving the phone durations and the acoustic features from the neural network.

Implementation 15

According to a fifteenth implementation, an apparatus for synthesizing cross-lingual speech may include at least one memory configured to store program code; and at least one processor configured to read the program code and operate as instructed by the program code, the program code including first receiving code configured to cause the at least one processor to receive a request for synthesizing speech, wherein the request for synthesizing speech comprises a target text document and a target language; first generating code configured to cause the at least one processor to generate phonetic transcriptions for the target text document; second generating code configured to cause the at least one processor to generate prosodic annotations for the target text document based on the target text document and the target language; third generating code configured to cause the at least one processor to generate phone durations and acoustic features based on the phonetic transcriptions and the prosodic annotations using a neural network; and first synthesizing code configured to cause the at least one processor to synthesize a speech corresponding to the target text document in the target language based on the generated phone durations and acoustic features.

Implementation 16

In the apparatus of implementation 15, the target text document may be in a first language, and the target language may be different from the first language.

Implementation 17

In the apparatus of implementations 15-16, the program code may further include, prior to the third generating code, a first receiving code configured to cause the at least one processor to receive the neural network from a training server.

Implementation 18

In the apparatus of implementations 15-17, the program code may further include a second receiving code configured to cause the at least one processor to receive a re-trained neural network from a training server, wherein the neural network is re-trained based on new training data.

Implementation 19

In the apparatus of implementations 15-18, the request for synthesizing speech may further comprise a speaker ID for a target speaker, and wherein the synthesized speech is in a voice of the target speaker.

Implementation 20

In the apparatus of implementations 15-19, the third generating code may comprise forth generating code configured to cause the at least one processor to generate a first set of vectors indicating phonemes in the phonetic transcriptions; fifth generating code configured to cause the at least one processor to generate a second set of vectors based on the prosodic annotations; first inputting code configured to cause the at least one processor to input the first set of vectors and the second set of vectors into the neural network ;and second receiving code configured to cause the at least one processor to receive the phone durations and the acoustic features from the neural network.

Implementation 21

According to a twenty first implementation, a non-transitory computer-readable medium may store instructions, the instructions comprising one or more instructions that, when executed by one or more processors of a device for synthesizing cross-lingual speech, cause the one or more processors to at least receive a request for synthesizing speech, wherein the request for synthesizing speech comprises a target text document and a target language; generate phonetic transcriptions for the target text document; generate prosodic annotations for the target text document based on the target text document and the target language; generate phone durations and acoustic features based on the phonetic transcriptions and the prosodic annotations using a neural network; and synthesize a speech corresponding to the target text document in the target language based on the generated phone durations and acoustic features.

Implementation 22

In the non-transitory computer-readable medium of implementation 21, the target text document may be in a first language, and the target language may be different from the first language.

Implementation 23

In the non-transitory computer-readable medium of implementations 21-22, the one or more instructions may cause the one or more processors to receive the neural network from a training server prior to generating the phone durations and the acoustic features.

Implementation 24

In the non-transitory computer-readable medium of implementations 21-23, the neural network may be trained using training data, wherein the training data comprises a plurality of speech samples in a plurality of languages, phonetic transcriptions corresponding to each of the plurality of speech samples, prosodic annotations corresponding to each of the plurality of speech samples, and speaker IDs of speakers associated with the plurality of speech samples.

Implementation 25

In the non-transitory computer-readable medium of implementations 21-24, the one or more instructions may cause the one or more processors to receive a re-trained neural network from a training server, wherein the neural network is re-trained based on new training data.

Implementation 26

In the non-transitory computer-readable medium of implementations 21-25, the request for synthesizing speech may further comprise a speaker ID for a target speaker, and wherein the synthesized speech is in a voice of the target speaker.

Implementation 27

In the non-transitory computer-readable medium of implementations 21-26, the generation of the phone durations and the acoustic features may comprise generating a first set of vectors indicating phonemes in the phonetic transcriptions; generating a second set of vectors based on the prosodic annotations; inputting the first set of vectors and the second set of vectors into the neural network; and receiving the phone durations and the acoustic features from the neural network.

Techniques consistent with the present disclosure provide, among other features, systems and methods for synthesizing cross-lingual speech. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for synthesizing cross-lingual speech, executed by a processor, the method comprising:
receiving a request for synthesizing speech, wherein the request for synthesizing speech comprises a target text document and a target language;
generating phonetic transcriptions for the target text document;
generating prosodic annotations for the target text document based on the target text document and the target language;
generating phone durations and acoustic features based on the phonetic transcriptions and the prosodic annotations using a neural network; and
synthesizing a speech corresponding to the target text document in the target language based on the generated phone durations and acoustic features.

2. The method of claim 1, wherein the target text document is in a first language, and the target language is different from the first language.

3. The method of claim 1, wherein, prior to generating the phone durations and the acoustic features, the method comprises receiving the neural network from a training server.

4. The method of claim 1, wherein the neural network is trained using training data, wherein the training data comprises a plurality of speech samples in a plurality of languages, phonetic transcriptions corresponding to each of the plurality of speech samples, prosodic annotations corresponding to each of the plurality of speech samples, and speaker identifications (IDs) of speakers associated with the plurality of speech samples.

5. The method of claim 1, wherein the method further comprises receiving a re-trained neural network from a training server, wherein the neural network is re-trained based on new training data.

6. The method of claim 1, wherein the request for synthesizing speech further comprises a speaker ID for a target speaker, and wherein the synthesized speech is in a voice of the target speaker.

7. The method of claim 1, wherein the generating of the phone durations and the acoustic features comprises:
generating a first set of vectors indicating phonemes in the phonetic transcriptions;
generating a second set of vectors based on the prosodic annotations;
inputting the first set of vectors and the second set of vectors into the neural network; and
receiving the phone durations and the acoustic features from the neural network.

8. A apparatus for synthesizing cross-lingual speech, the apparatus comprising:
at least one memory configured to store program code; and
at least one processor configured to read the program code and operate as instructed by the program code, the program code including:
first receiving code configured to cause the at least one processor to receive a request for synthesizing speech, wherein the request for synthesizing speech comprises a target text document and a target language;
first generating code configured to cause the at least one processor to generate phonetic transcriptions for the target text document;
second generating code configured to cause the at least one processor to generate prosodic annotations for the target text document based on the target text document and the target language;
third generating code configured to cause the at least one processor to generate phone durations and acoustic features based on the phonetic transcriptions and the prosodic annotations using a neural network; and
first synthesizing code configured to cause the at least one processor to synthesize a speech corresponding to the target text document in the target language based on the generated phone durations and acoustic features.

9. The apparatus of claim 8, wherein the target text document is in a first language, and the target language is different from the first language.

10. The apparatus of claim 8, wherein the program code further includes, prior to the third generating code, a first receiving code configured to cause the at least one processor to receive the neural network from a training server.

11. The apparatus of claim 8, wherein the program code further includes a second receiving code configured to cause the at least one processor to receive a re-trained neural network from a training server, wherein the neural network is re-trained based on new training data.

12. The apparatus of claim 8, wherein the request for synthesizing speech further comprises a speaker ID for a target speaker, and wherein the synthesized speech is in a voice of the target speaker.

13. The apparatus of claim 8, wherein the third generating code comprises:
forth generating code configured to cause the at least one processor to generate a first set of vectors indicating phonemes in the phonetic transcriptions;
fifth generating code configured to cause the at least one processor to generate a second set of vectors based on the prosodic annotations;
first inputting code configured to cause the at least one processor to input the first set of vectors and the second set of vectors into the neural network ;and
second receiving code configured to cause the at least one processor to receive the phone durations and the acoustic features from the neural network.

14. A non-transitory computer-readable medium storing instructions, the instructions comprising: one or more instructions that, when executed by one or more processors of a device for synthesizing cross-lingual speech, cause the one or more processors to at least:
receive a request for synthesizing speech, wherein the request for synthesizing speech comprises a target text document and a target language;
generate phonetic transcriptions for the target text document;
generate prosodic annotations for the target text document based on the target text document and the target language;
generate phone durations and acoustic features based on the phonetic transcriptions and the prosodic annotations using a neural network; and
synthesize a speech corresponding to the target text document in the target language based on the generated phone durations and acoustic features.

15. The non-transitory computer-readable medium of claim 14, wherein the target text document is in a first language, and the target language is different from the first language.

16. The non-transitory computer-readable medium of claim 14, wherein the one or more instructions cause the one or more processors to receive the neural network from a training server prior to generating the phone durations and the acoustic features.

17. The non-transitory computer-readable medium of claim 14, wherein the neural network is trained using training data, wherein the training data comprises a plurality of speech samples in a plurality of languages, phonetic transcriptions corresponding to each of the plurality of speech samples, prosodic annotations corresponding to each of the plurality of speech samples, and speaker IDs of speakers associated with the plurality of speech samples.

18. The non-transitory computer-readable medium of claim 14, wherein the one or more instructions cause the one or more processors to receive a re-trained neural network from a training server, wherein the neural network is re-trained based on new training data.

19. The non-transitory computer-readable medium of claim 14, wherein the request for synthesizing speech further comprises a speaker ID for a target speaker, and wherein the synthesized speech is in a voice of the target speaker.

20. The non-transitory computer-readable medium of claim 14, wherein the generation of the phone durations and the acoustic features comprises:
generating a first set of vectors indicating phonemes in the phonetic transcriptions;
generating a second set of vectors based on the prosodic annotations;
inputting the first set of vectors and the second set of vectors into the neural network; and
receiving the phone durations and the acoustic features from the neural network.
